(19) United States
(12) Patent Application Publication
(10) Pub. No.: US 2025/0063087 A1
(43) Pub. Date: Feb. 20, 2025

(54) LOGICAL INTERFACES FOR MULTI-TIER ARCHITECTURES

(71) Applicant: NVIDIA Corporation, Santa Clara, CA (US)

(72) Inventors: Arul Selvan Sekar, Bothell, WA (US); Elliot Andrew Simon, San Diego, CA (US)

(21) Appl. No.: 18/233,627

(22) Filed: Aug. 14, 2023

(51) Int. Cl. H04L 67/12

(52) U.S. Cl. CPC H04L 67/12; G06F 9/541

(57) ABSTRACT

In various examples, one or more logical interfaces are used to represent functional requirements of an architecture specification. The logical interfaces may indicate one or more dependencies of functionalities associated with a plurality of components of the architecture. Using the logical interfaces, one or more physical interfaces between the components may be recursively determined and used to perform an operation using the plurality of components.

### BACKGROUND

Development of software and hardware architectures may be very complex, especially where development involves numerous teams of developers that may each be working on one or more distinct components and/or elements that need to function correctly with other components. In order to promote the interoperability of these separately developed elements, documentation that defines how each element is to operate and interact with other elements must be generated and updated as more features and/or functionality are included in the architecture. Thus, as an architecture is developed and/or revised, developers use the documentation to determine the scope, interfaces, and/or manner in which data is exchanged.

However, for architectures that are large and may be produced by a hierarchy of distinct groups of developers, documentation that defines the interfacing between elements may be too large and complex to effectively use and/or maintain. For example, documentation for a development platform may comprise thousands of pages, making it cumbersome to use. For an architecture to be verified, the expectations of each element must be fully and clearly captured which may require documenting an expected outcome for each element. Conventionally, application programming interfaces (APIs) have attempted to capture the requirements of each element in an architecture. However, APIs often do not provide enough information to easily discern what one element may require from another element (e.g., such as a child element) or which portions of an architecture may be vital to the correct operation of an application and which other portions may be less vital. Further, conventional methods of describing an architecture, in order to fully specify the APIs of every possible interface, are highly complex and prohibitive to the understanding, analysis, and/or verification of an architecture by a designer.

### SUMMARY

Embodiments of the present disclosure relate to logical interfaces for multi-tier architectures. Systems and methods are disclosed that use logical interfaces that define high level requirements of the functionality of an element. For example, logical interfaces may define an architecture that captures requirements of each element and/or sub-element in the architecture. Thus, the requirements for each element of the architecture may be traced down through any sub-elements to the physical interface details of the architecture.

In contrast to conventional systems, such as those described above, logical interfaces that define high level requirements of the functionality of various elements within an architecture enable an architecture to specify the properties of shared boundaries between elements only as necessary to describe how functionalities will be exercised to satisfy the specified requirements. This may negate the need for additional specifications in the architecture that are not necessary for the decomposition, analysis, and/or verification of an element within the architecture. Further, defining relationships between elements using logical interfaces enables reduced duplication of expectations and policies associated with the elements since higher level elements will capture the requirements of lower-level elements. An architecture defined using logical interfaces allows for vertical and horizontal freedom when designing/modifying an architecture since a higher-level architecture may define expectations or policies of a shared boundary between elements, without restricting the specific mechanisms of each element used to satisfy the expectations.

### BRIEF DESCRIPTION OF THE DRAWINGS

The present systems and methods for logical interfaces for multi-tier architectures are described in detail below with reference to the attached drawing figures, wherein:

FIG. 1 is a block diagram illustrating an example architecture specification system, in accordance with some embodiments of the present disclosure;

FIG. 2 is a diagram showing an interface specification, in accordance with some embodiments of the present disclosure;

FIG. 3 is a diagram showing a physical interface specification, in accordance with some embodiments of the present disclosure;

FIG. 4 is an example diagram of an architecture traceability model, in accordance with some embodiments of the present disclosure;

FIG. 5 is an example architecture design, in accordance with some embodiments of the present disclosure;

FIG. 6 is a flow diagram showing a method for performing an interface concretization, in accordance with some embodiments of the present disclosure;

FIG. 7 is a flow diagram showing a method for identifying physical interfaces, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure; and

FIG. 9 is a block diagram of an example computing device suitable for use in implementing some embodiments of the present disclosure.

### DETAILED DESCRIPTION

Systems and methods are disclosed related to logical interfaces for multi-tier architectures. The present application may define an architecture using one or more logical interfaces that define one or more high level requirements of the functionality of an element. For example, logical interfaces may define an architecture that captures requirements of each element and/or sub-element (e.g., child element) in the architecture. For example, a logical interface may specify requirements for one or more child elements without specifically defining a function, instruction, and/or other parameters used by the child elements. For example, an element may require a child element to perform a particular task, but how that task is to be performed may not be defined by the element. An architecture (e.g., an architectural design) may define and/or specify one or more elements and their interactions in one or more hierarchical structures. Thus, the requirements for each element of the architecture may be traced down through any sub-elements to the physical interface details of the architecture.

In at least one embodiment, an interface is a shared boundary (e.g., relationship) between components (e.g., elements). For example, an interface may represent a possible interaction between a first component and a second component. In at least one embodiment, a component may represent one or more elements, units, and/or external entities. An element may represent a system and/or a portion of a system including one or more sub-elements, hardware, software, hardware parts, and/or software units. One or more components may provide an interface associated with one or more dependent components, such as a sub-element, that may require the interface to perform one or more interactions between the dependent components and the one or more components providing the interface. In at least one embodiment, an interface may be represented in a directed graph (e.g., a graph comprising a set of vertices connected by directed edges) in which the vertices of the graph may represent one or more components and one or more edges of the graph may represent one or more interfaces.

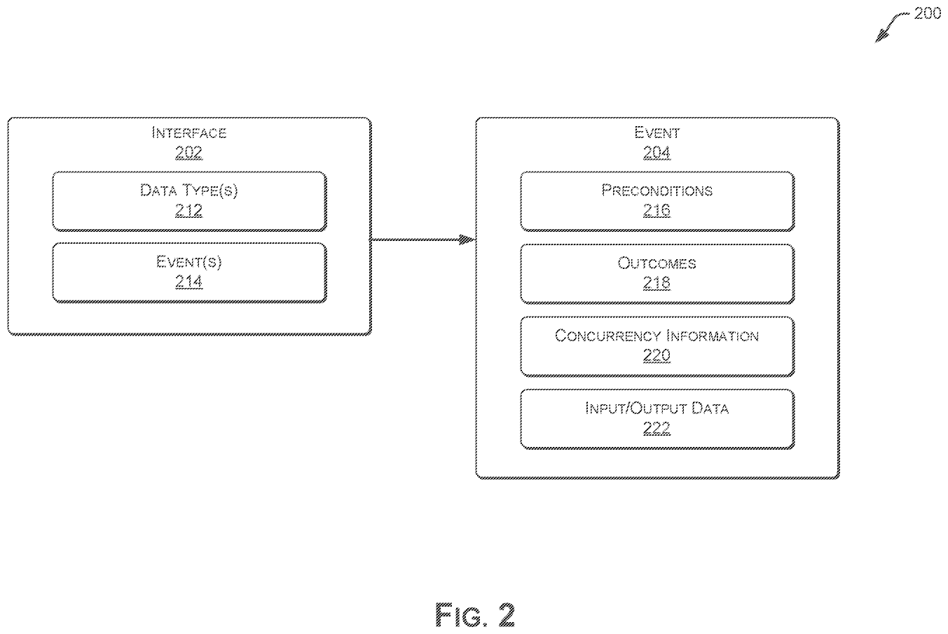

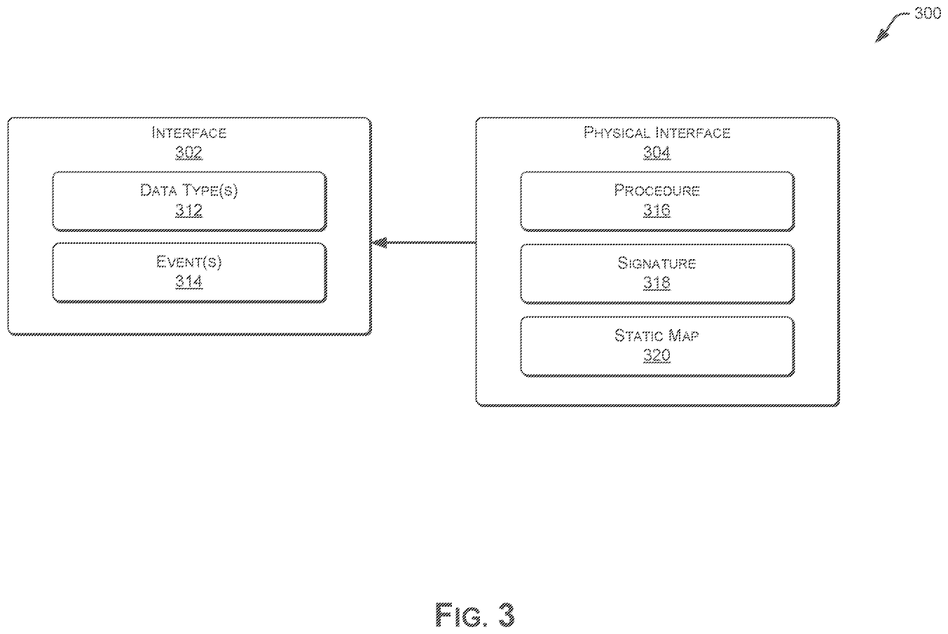

In some examples, an interface may be a physical interface. A physical interface, such as physical inface 304 of FIG. 3, may define one or more design specifications of a shared boundary between two or more components. In some examples, a physical interface may specify one or more parameters necessary to implement a shared boundary between two or more components. In at least one embodiment, an interface may be a logical interface, such as interface 202 of FIG. 2. A logical interface may be an architectural specification (e.g., describing one or more policies of a shared boundary) of a shared boundary between two or more components (e.g., elements). For example, a logical interface may represent a connection between two or more elements based on dependencies between a functionality associated with the elements. In some embodiments, a logical interface may expose a set of interfaces, which may be one or more logical interfaces and/or physical interfaces.

In at least one embodiment, an interface may be represented as a set of one or more events, such as event 204 of FIG. 2. An event is one or more interactions between components over a shared boundary, such as an interface. For example, an event may include one or more properties that specify one or more preconditions, outcomes, and/or data flows for using an interface between components. An event may include one or more preconditions, outcomes, concurrencies, and/or input/output data. For example, an event may include preconditions that describe prerequisites for exercising the event. In another example, an event may include one or more outcomes that describe one or more results of exercising the event. An event may include one or more concurrencies that represent policies on occurrence of other events during the execution of the event. An event may include descriptions of input and/or output data that represent data flow when exercising the event. In at least one embodiment, an event may be a physical event which represents a utilization of one or more procedures, such as a data field or method, over one or more physical interfaces. For example, a physical interface may define a set of one or more physical events that specify one or more possible interactions over the shared boundary of the physical interface. In at least one embodiment, an event may be a logical event. A logical event may represent a utilization of one or more functions of an element exposed over one or more logical interfaces. For example, a logical event may specify one or more policies for exercising a function within an environment of one or more elements.

Events may be specified according to an event identifier. For example, an event may have a unique identifier distinct from identifiers of one or more other events. Events may be specified with one or more attributes.

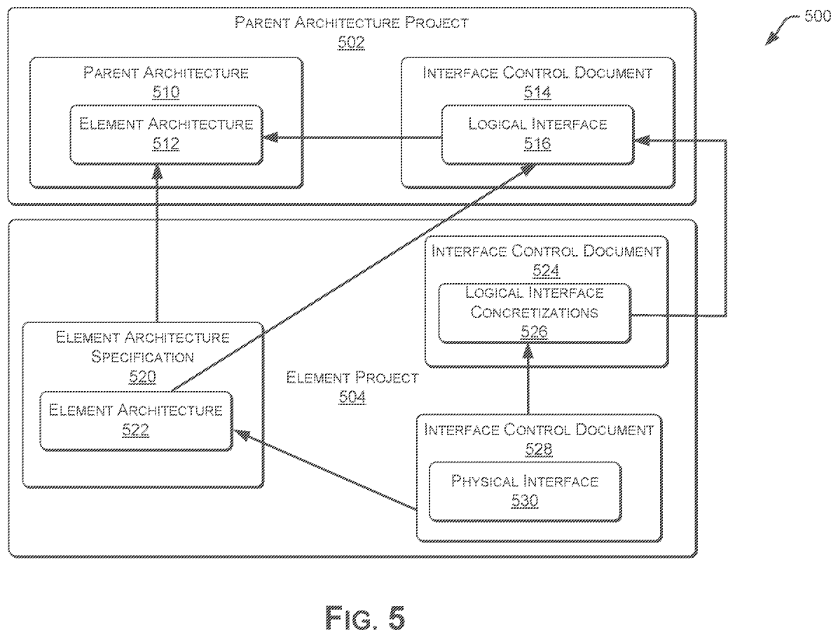

In at least one embodiment, an interface control specification describes a specification of one or more interfaces. For example, an interface control specification may describe one or more elements and one or more interfaces corresponding to the one or more elements. In some examples, an interface control specification may include one or more events associated with one or more interfaces. In at least one embodiment, an interface control specification may ensure compatibility between two or more elements of an architecture. In some examples, an interface control specification may be a document, such as in the case of a document-based architecture. In at least one embodiment, an interface control specification may represent one or more work products relationships associated with one or more interfaces. An interface control document may include one or more properties of an interface that are defined during a specification of a parent architecture that necessitates the interface. In such examples, concretization attributes of a logical interface may be defined during the specification of one or more components that concretize one or more logical events into events between child components and/or one or more physical events. In at least one embodiment, concretization of a logical interface may be completed once the interface is concretized to a set of physical interfaces. In some examples, an interface control specification, such as described below in relation to architecture design 500 of FIG. 5, may be represented as a version-controlled project that is stored in association with one or more software and/or hardware corresponding to an architecture.

In at least one embodiment, a logical interface between two or more elements of an architecture may be transformed (e.g., concretized) to one or more interfaces. For example, a logical interface may be recursively analyzed to generate a set of one or more other interfaces (e.g., physical interface). Transforming an interface may include determining a set of one or more physical interfaces between two or more child elements of an element. A logical event may be transformed to a set of physical events supported over one or more transformed events. In at least one embodiment, one or more preconditions may be transformed to combinational logic or one or more preconditions of the transformed events. Outcomes may be transformed as a combinational logic of outcomes of the transformed outcomes. Concurrency may be transformed as a combinational logic of concurrencies of the transformed concurrencies. An input and/or output object may be transformed to a set of input and/or output objects of the transformed events.

In at least one embodiment, one or more concretizations of a logical interface may be specified when a logical interface is concretized to a set of interfaces between child components, a logical event is concretized as a set of events supported over concretized interfaces, a precondition is concretized as a combinational logic of preconditions of concretized events, an outcome in concretized as a combinational logic of outcomes of concretized events, a concurrency is concretized as a combinational logic of concurrencies of concretized events, and/or an input/output object is concretized as a set of input and/or output objects of concretized events.

In at least one embodiment, one or more elements within an architecture may encapsulate one or more child elements. For example, an element may include one or more distinct child elements. For a particular element, an open-box specification of that element may define one or more expectations and/or one or more policies on child elements by specifying a closed-box specification for the child elements. In this way, open-box specifications for a child element may be deferred until an architecture is defined at a level corresponding to the child elements. An open-box specification of an element may define the expectations and/or policies of one or more child elements using one or more logical interfaces. In some examples, a functionality of a child element of an element (e.g., a parent element) may be described as a dependency on one or more functionalities of one or more other child elements. A dependency between child elements may be realized as an event over an interface between each respective child element.

A closed-box specification of one or more elements in an architecture may include requirements for the one or more elements by specifying the utilization of one or more functionalities exposed between the elements. For example, a closed-box specification may include indications of one or more events defined by a parent architecture (e.g., a higher tier of architecture). The functionalities of an element may be decomposed into a set of functionalities associated with child elements, with possible dependencies between the child elements. Child elements may be inter-dependent with other child elements, where dependencies exist between child elements having different parent elements. Child elements may be intra-dependent, where dependencies exist between a plurality of child elements having a same parent element.

Each dependency of functionalities between two or more elements (e.g., parent elements) at a particular architecture level (e.g., tier) may be represented by a set of inter-dependent functionalities between the child elements of the two or more elements. This set of inter-dependent functionalities may be exposed over one or more interfaces between these child elements. These inter-dependent functionalities may be exposed according to one or more policies of the shared boundary already identified between the parent elements. The interfaces identified between the child elements may be defined in accordance with the policies defined by one or more logical interfaces between the parent elements. In at least one embodiment, an open-box specification of parent elements concretize (e.g., define a 1:N relationship for) each logical event between parent elements to a set of events between the child elements. Intra-dependent functionalities may be exposed over one or more interfaces between respective child elements of a parent element. In some examples, one or more requirements for the child elements may reinforce a closed-box specification of the child elements and one or more events between them as defined by corresponding architecture. The process of concretizing, or otherwise decomposing, an architecture by expressing the functionalities of a higher-level element of the architecture with interfaces between child elements of a lower level of the architecture may be performed recursively. This process may be performed until a specification of an architecture completes the breakdown for each tier of child elements associated with a parent element. When the concretization process is complete, a logical interface of the highest-level elements may be represented by a set of physical interfaces between the elements.

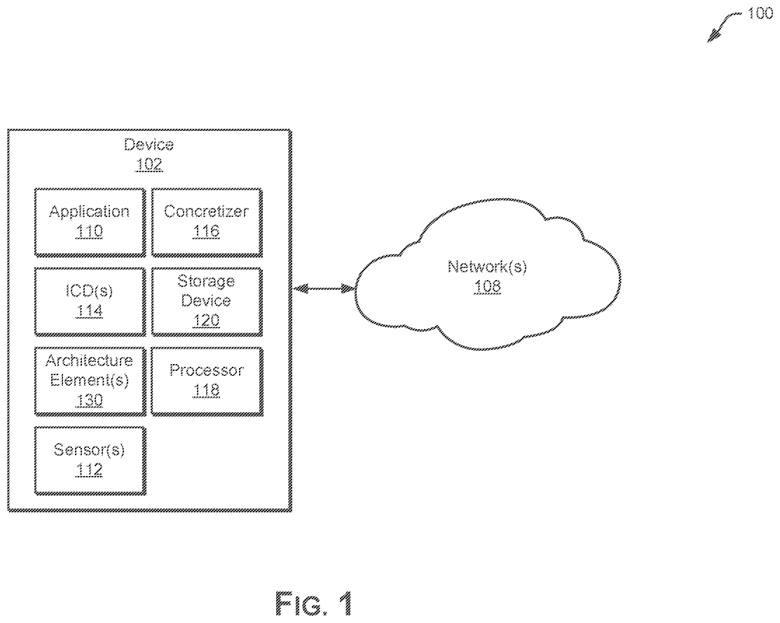

With reference to FIG. 1, FIG. 1 is a block diagram illustrating an example architecture specification system 100 (“system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

System 100 may include a device 102 and/or one or more network(s) 108. Device 102 may include an application 110, a concretizer 116, one or more interface control documents (“ICDs”) 114, one or more architecture element(s) 130, one or more sensor(s) 112, a storage device 120, and/or one or more processors 118.

Components of system 100 may be configured to communicate across one or more networks, such as network(s) 108, and/or other network types described herein. Network(s) 108 may include one or more networks of any number of network types. In some examples, network(s) 108 include one or more data bus protocols and/or topologies (e.g., a Controller Area Network (“CAN”), FlexRay, Ethernet, etc.). One or more components of system 100 may be configured to use one or more network interfaces to connect the one or more components of system 100 over network(s) 108.

Device 102 may include one or more components for performing one or more operations (e.g., architecture specification, analysis, and/or verification, etc.) associated with an autonomous or semi-autonomous machine. For example, device 102 may include one or more components to define an architecture using one or more logical interfaces that define one or more high level requirements of the functionality of an element, one or more components for performing calculations (e.g., using processor 118), and/or one or more components for making predictions corresponding to an autonomous or semi-autonomous machine. As an example, device 102 may define an architecture used to perform one or more operations associated with an autonomous machine, a semi-autonomous machine, and/or other hardware device.

Processor 118 may include one or more components for processing data associated with one or more autonomous or semi-autonomous machine operations. In some embodiments, processor 118 may provide additional and/or alternative processing to the processing performed by device 102. In some examples, processor 118 may perform processing associated with system 100. For example, processor 118 may be configured to process measurement data from one or more inertial measurement unit sensors, and/or other sensors, such as LiDAR and cameras associated with device 102. In some embodiments, processor 118 may be used to perform one or more operations associated with architecture element(s) 130 and/or sensor(s) 112. Architecture elements may include one or more sub-elements, hardware, software, hardware parts, and/or software parts and may be used to perform one or more computing operations.

Application 110 may include one or more components configured to define an architecture having one or more components, such as architecture element(s) 130. For example, application 110 may access interface control document(s) 114 to identify one or more logical and/or physical interfaces associated with components, such as architecture element(s) 130 and/or sensor(s) 112. In some examples, application 110 may use concretizer 116 to determine a set of physical interfaces that concretize one or more logical interfaces to one or more procedures (e.g., field or method) that may be performed by the architecture element(s) 130 using processor 118. The physical interfaces may comprise physical events that represent the utilization of a procedure over the physical interfaces. In such an example, the set of physical events may specify possible interactions over a boundary shared by architecture element(s) 130.

Interface control document(s) 114 (“ICDs”) may include one or more components configured to indicate one or more specifications of an interface. For example, ICDs 114 may include one or more logical and/or physical interfaces associated with an element of an architecture, such as architecture element(s) 130 and/or sensor(s) 112. ICDs 114 may be used (e.g., by application 110) to identify one or more events associated with one or more interfaces (e.g., such as interface 202 of FIG. 2) associated with architecture element(s) 130. In at least one embodiment, ICD(s) may be used by application 110 to ensure compatibility between architecture element(s) 130. In at least one embodiment, ICDs 114 may be used to define work products relationships associated with one or more interfaces (see architecture design 500 of FIG. 5). In at least one embodiment, ICDs 114 may be used by application 110 and/or concretizer 116 to determine concretization of a logical interface into a set of physical interfaces (e.g., such as physical interface 304 of FIG. 3). In some examples, once a set of set of physical interfaces has been determined, device 102 may perform one or more operations using the set of physical interfaces (e.g., using the architecture elements(s) 130 associated with the physical interfaces).

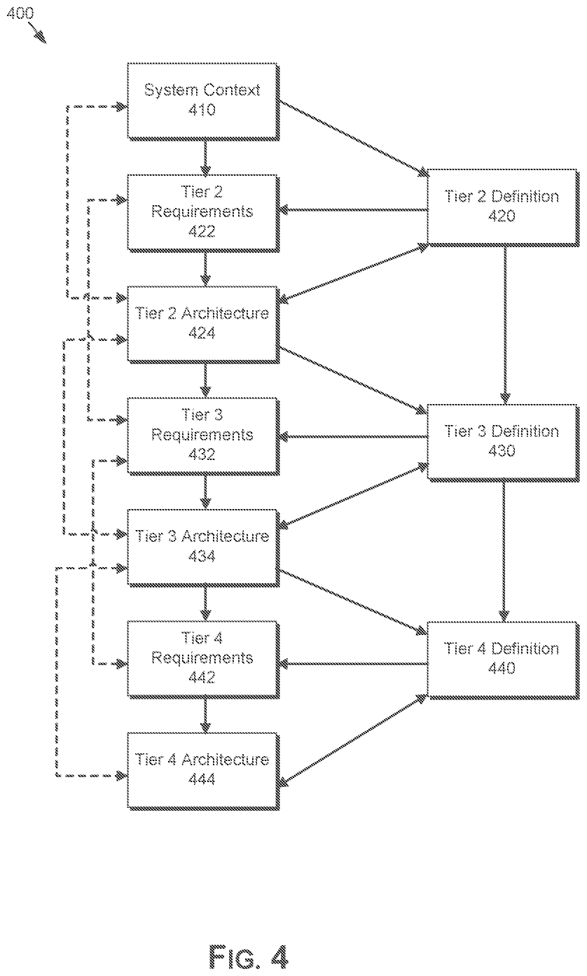

Concretizer 116 may include one or more components configured to concretize one or more logical interfaces to a set of one or more physical interfaces. For example, concretizer 116 may use processor 118 to recursively process each level of a plurality of levels in an architecture to determine one or more physical interfaces between elements and sub-elements of the architecture (see architecture traceability model 400 of FIG. 4). Concretizer 116 may identify physical interfaces corresponding to architecture element(s) 130. In some examples, once concretizer 116 has identified one or more physical interfaces, these interfaces may be added to ICD(s) 114 and used to maintain an architecture specification.

Concretizer 116 may transform a logical event, indicated by ICD(s) 114, to a set of physical events associated with architecture element(s) 130. Concretizer 116 may transform one or more preconditions, outcomes, concurrencies, and/or input/output values using combinational logic and one or more logical interfaces (such as interface 202 of FIG. 2).

In at least one embodiment, concretizer 116 may access an open-box specification of architecture element(s) 130 that may define one or more expectations and/or one or more policies on child elements of architecture element(s) 130 by specifying a closed-box specification for the child elements. Concretizer 116 may use the decomposed functionalities of architecture element(s) 130 represented by a set of functionalities associated with child elements of architecture element(s) 130, with possible dependencies between the child elements. In at least one embodiment, a decomposition of functionalities is used to transform one or more logical events to one or more other logical events and/or one or more physical events. Concretizer 116 may be used by application 110 to define the functionalities of a higher-level element of architecture element(s) 130 with interfaces between child elements of a lower level of architecture element(s) 130. This process may be performed recursively until a specification of architecture element(s) 130 completes the breakdown for each tier of child elements associated with architecture element(s) 130. For example, in an architecture having a hierarchy of four tiers of elements, the logical interfaces of the third tier may be concretized once the physical interfaces of the fourth tier (the lowest level tier) and may subsequently be used to concretize the logical interfaces of the second tier into a set of physical interfaces corresponding to the second tier. In such an example, the set of physical interfaces determined for each level of an architecture may be used to recursively concretize logical interfaces of a higher level, until physical interfaces have been determined for each level of the architecture. When the concretization process is complete, a logical interface of the highest-level elements may be represented by a set of physical interfaces between the elements in architecture element(s) 130.

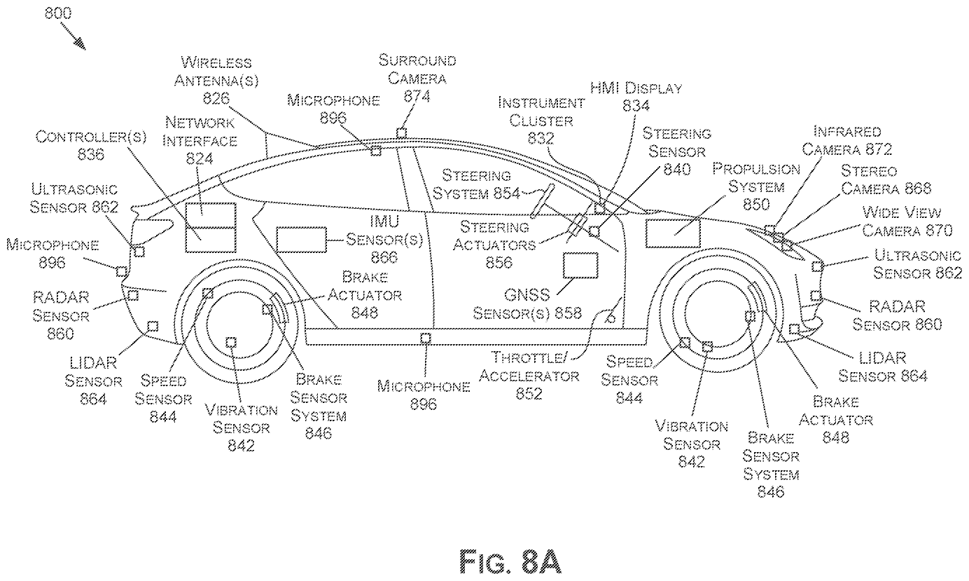

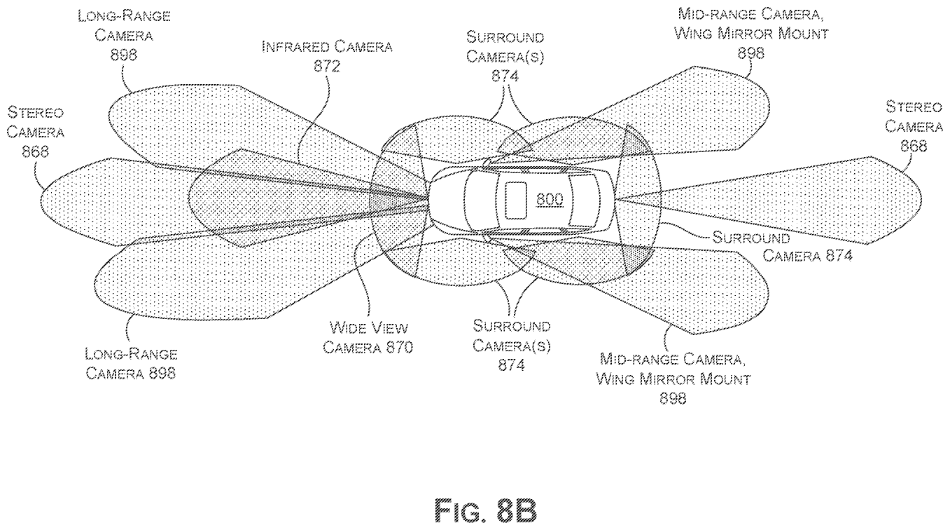

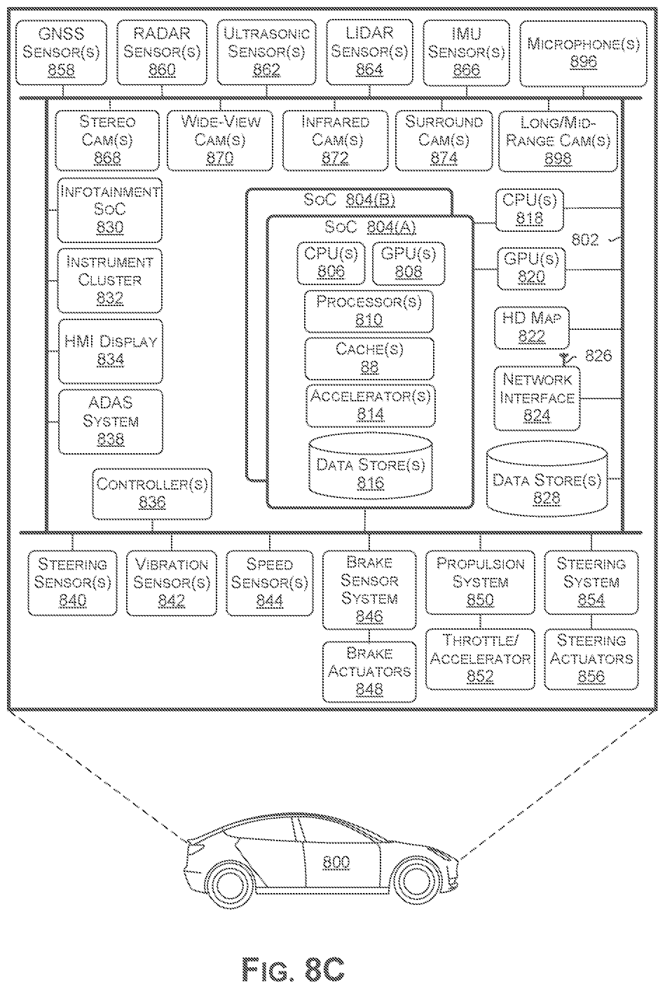

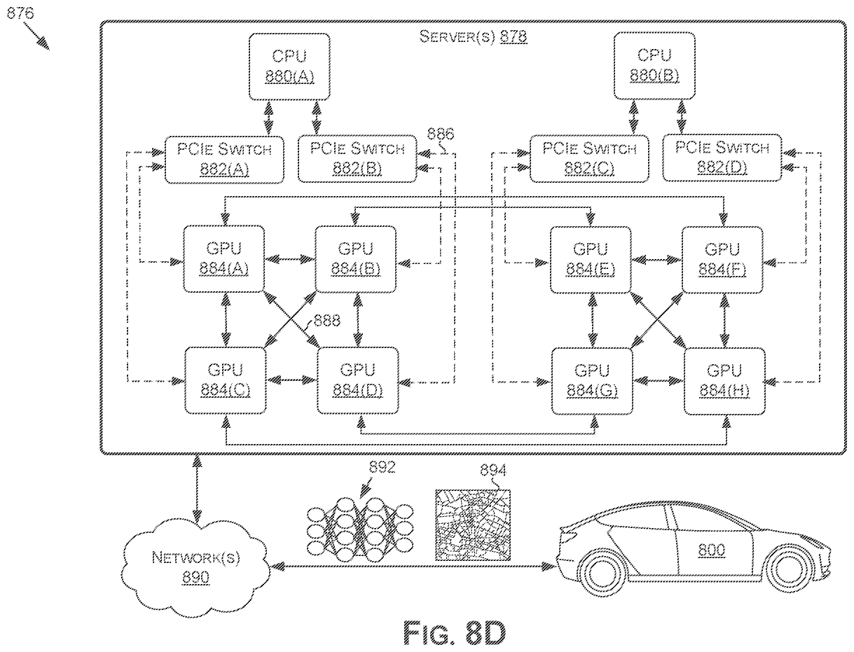

Sensor(s) 112 may include one or more components for collecting data associated with system 100. For example, system 100 may include one or more sensor(s) 112 that collect and/or generate sensor data associated with the operations of one or more autonomous or semi-autonomous machines. As an example, sensor(s) 112 may include one or more RADAR sensors, cameras, ultrasonic sensors, LiDAR sensors, accelerometers, gyroscopes, magnetometers, altimeters, and/or any other suitable sensor, such as those described in relation to vehicle 800 of FIGS. 8A-8D. As mentioned above, in some embodiments, one or more sensor(s) 112 may include one or more processors, that may be configured to perform one or more operations in association to an architecture. For example, sensor(s) 112 may measure one or more metrics in response to an event indicated by an architecture. In such an example, sensor(s) 112 may generate one or more sensor values in response to a routine performed by one or more other components, such as application 110. For instance, a temperatures sensor may generate temperature data in response to one or more function calls and/or instructions.

The device 102 may include memory (not shown) that may be implemented as one or more non-transitory processor-readable medium storing processor executable instructions that when executed by the processor 118 implement application 110, concretizer 116, ICD(s) 114, and/or the like. The memory (not shown) may be implemented as or using storage device 120. The processor 118 may include one or more circuits that perform at least a portion of the instructions. The processor 118 may be implemented, for example, using a main central processing unit (“CPU”) complex, one or more microprocessors, one or more microcontrollers, one or more graphics processing units (“GPU(s)”), one or more data processing units (“DPU(s)”), and/or the like. By way of additional non-limiting examples, the memory (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). The device 102 may include a user interface (not shown) that a user may use to enter user input into the device 102. The user interface (not shown) may include a display device (not shown) that the user may use to view information generated and/or displayed by the device 102. The processor 118, the user interface, and/or the memory may communicate with one other over one or more connections, such as a bus, a Peripheral Component Interconnect Express (“PCIe”) connection (or bus), and/or the like.

FIG. 2 is a diagram showing an interface specification 200, in accordance with some embodiments of the present disclosure. Interface specification 200 may include an interface 202 (e.g., such as an interface described above). In at least one embodiment, interface 202 may include one or more of data type(s) 212 and/or event(s) 214. Event(s) 214 may correspond to one or more events such as event 204. An event, such as event 204 may include one or more precondition 216, outcomes 218, concurrency information 220, and/or input/output data 222.

In some examples, preconditions 216 may represent one or more prerequisites for exercising event 204. For example, preconditions 216 may indicate one or more actions and/or operations that must be performed before event 204 may be performed. Outcomes 218 may include one or more indications of a result that is generated in response to event 204 being performed. For example, outcomes 218 may specify one or more status values upon performance of event 204. As a further example, if event 204 is to read a temperature value associated with a sensor (e.g., sensor(s) 112 of FIG. 1), outcomes 218 may indicated that the temperature value was read successfully, or alternatively, not read successfully. Concurrency information 220 includes information indicating one or more policies associated with the occurrence of other events that are performed during the execution and/or performance of event 204. For example, concurrency information 220 may indicate one or more other events that run concurrently, or otherwise in association with, event 204. Input/output data 222 may include one or more representations of data flow when exercising event 204. For example, input/output data 222 may include indication of one or more input and/or output parameters that are input to, or output from, event 204 when event 204 is performed.

FIG. 3 is a diagram showing a physical interface specification 300, in accordance with some embodiments of the present disclosure. Physical interface specification may extend an interface specification such as interface specification 200 of FIG. 2. Physical interface specification 300 may include an interface 302 (e.g., such as a physical interface described above) and a physical interface 304. In at least one embodiment, interface 302 may include one or more of data type(s) 312 and/or event(s) 314. Event(s) 314 may correspond to one or more events such as event 204 of FIG. 2. Physical interface 304 may include one or more of procedure 316, signature 318, and/or a static map 320. In some examples, physical interface 304 may extend the parameters of interface 302.

In at least one embodiment, procedure 316 may include one or more fields or methods. For example, procedure 316 may include information indicating one or more methods and/or functions and associated data fields. Signature 318 may include one or more input and/or output parameters of procedure 316. For example, signature 318 may include input/output parameters for one or more methods indicated by procedure 316. Static map 320 may include one or more of a procedure value and/or signature values used to exercise a physical event. For example, static map 320 may include procedure values associated with procedure 316 and/or signature values associated with signature 318 and used to perform a physical event associated with physical interface 304.

FIG. 4 is an example diagram of an architecture traceability model 400 (“model 400”), in accordance with some embodiments of the present disclosure. Model 400 may be specified at least in part by application 110 and/or ICDs 114 of FIG. 1. Model 400 may include one or more specifications of one or more tiers of an architecture. For example, model 400 may include one or more tiers, such as system context 410, tier 2 architecture 424, tier 3 architecture 434, and/or tier 4 architecture 444, each specifying a different tier of model 400.

Model 400 may include one or more requirement specifications, such as tier 2 requirements 422, tier 3 requirements 432, and/or tier 4 requirements 442. Model 400 may include one or more tier X definitions, such as tier 2 definition 420, tier 3 definition 430, and/or tier 4 definition 440 that describes one or more interfaces associated with components at each tier of model 400.

In some embodiments, system context 410 may describe a highest-level element of an architecture represented by model 400. For example, system context 410 may represent an operating system and one or more interfaces provided by that operating system. System context 410 may include one or more lower tiers of model 400, such as tier 2 architecture 424, tier 3 architecture 434, and/or tier 4 architecture 444. Lower tiers of model 400 describe components that meet the functional expectations of higher tiers of model 400. For example, tier 2 architecture 424 may describe how tier 2 requirements are satisfied and may define one or more components of one or more lower levels of model 400, such as tier 3 architecture 434. Tier 3 architecture 434 may describe how tier 3 requirements are satisfied and may define one or more components of one or more lower levels of model 400, such as tier 4 architecture 444.

Functionality of each respective tier in relation to one or more other tiers may be specified by requirement specifications and/or tier definitions. Tier requirements may specify expected functionality that is to be provided by each tier of model 400 and may also include indications of one or more interfaces and/or interface characteristics used to provide the indicated functionality. For example, tier 2 requirements 422 may include information that represent expectations of system context 410 of functionalities to be provided by tier 2 architecture 424. Similarly, tier 3 requirements 432 define expectations for functionality to be provided to tier 2 architecture 424 by tier 3 architecture 434. As a further example, tier 4 requirements 442 define expectations for functionality to be provided to tier 3 architecture 434 by tier 4 architecture 444.

Tier definitions may include information that describes one or more interfaces associated with components at each tier of model 400. For example, tier definitions may include one or more ICDs that formalize expectations and/or characteristics of one or more interfaces. The tier definitions may be concretized by a tier architecture into one or more definitions associated with a different tier of model 400. For example, one or more interfaces may be concretized by tier 2 architecture 424 into interfaces associated with tier 3 architecture 434 (e.g., satisfying one or more expectations of tier 2 architecture 424 by tier 3 architecture 434). In some examples, one or more interfaces may be concretized by tier 2 architecture 424 into one or more components associated with tier 3 architecture 434. In a similar example, one or more interfaces may be concretized by tier 3 architecture 434 into interfaces associated with tier 4 architecture 444 (e.g., satisfying one or more expectations of tier 3 architecture 434 by tier 4 architecture 444). In some examples, one or more interfaces may be concretized by tier 3 architecture 434 into one or more components associated with tier 4 architecture 444. Interfaces may be concretized at each tier of model 400 until physical interfaces are defined.

FIG. 5 is an example architecture design 500, in accordance with some embodiments of the present disclosure. Architecture design 500 may be implemented at least in part by one or more processors, such as processor 118 of FIG. 1. Architecture design 500 may specify one or more relationships between one or more specifications used to define architecture design 500. Architecture design 500 may include one or more interface control documents, such as interface control document 514, interface control document 524, and/or interface control document 528. The interface control documents may be stored as a version-controlled project in association to work products that utilized the attributes of interfaces defined in the ICDs. For example, interface control document 514 may define one or more logical interfaces 516 used by parent architecture 510 and may be stored alongside the parent architecture 510 as part of parent architecture project 502. Similarly, interface control document 524 and/or interface control document 528 may define one or more logical interface concretizations 526 and/or physical interface 530 used by element architecture 520 and may be stored alongside the element architecture 520 as part of element project 504, that may be maintained separately from parent architecture project 502.

Architecture design 500 may include logical interface concretizations 526 that may specify event concretizations associated with element project 504. Interface control document 528 may include one or more indications of a physical interface 530 that specify properties of one or more physical interfaces of element project 504. Once the physical interface 530 has concretized the logical interface 516 in the form of the logical interface concretizations 526, the open-box element architecture 522 may be defined as part of the element architecture specification 520 and provided to the parent architecture 510 as a closed-box element architecture 512.

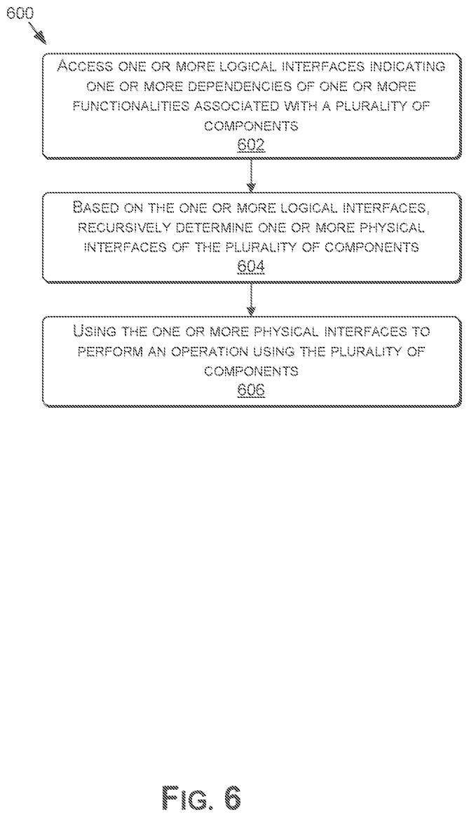

Now referring to FIG. 6, each block of a method 600, described herein, comprises a computing process that may be performed using any combination of hardware, firmware, and/or software. For instance, various functions may be carried out by a processor executing instructions stored in memory. Method 600 may also be embodied as computer-usable instructions stored on computer storage media. Method 600 may be provided by a standalone application, a service or hosted service (standalone or in combination with another hosted service), or a plug-in to another product, to name a few. In addition, method 600 is described, by way of example, with respect to system 100 of FIG. 1. However, these methods may additionally or alternatively be executed by any one system, or any combination of systems, including, but not limited to, those described herein.

FIG. 6 is a flow diagram showing method 600 for performing an interface concretization, in accordance with some embodiments of the present disclosure. At block 602, application 110 (see FIG. 1) (e.g., performed by processor 118 illustrated in FIG. 1) accesses one or more logical interfaces indicating one or more dependencies of one or more functionalities associated with a plurality of components. For example, one or more logical interfaces (specified by ICD(s) 114 of FIG. 1) may be accessed and/or provided to one or more processors, such as processor 118 (see FIG. 1), by application 110.

At block 604, processor 118 (see FIG. 1) may be used to determine one or more physical interfaces of the plurality of components based on the one or more logical interfaces accessed at block 602. For example, processor 118 of FIG. 1, may be used to recursively concretize the one or more logical interfaces into a set of one or more physical interfaces between architecture element(s) 130.

At block 606, application 110 (see FIG. 1) performs and/or causes performance of one or more operations using the plurality of physical interfaces determined at block 604. For example, application 110 may use processor 118 to perform one or more operations using parameters specified by one or more physical interfaces determined in associated with architecture element(s) 130. After block 606, method 600 may terminate.

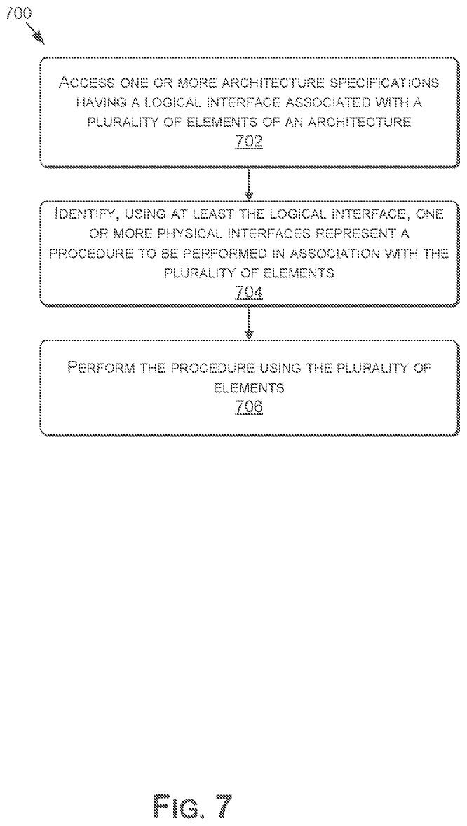

Now referring to FIG. 7 each block of method 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 700 is described, by way of example, with respect to the blah blah system of FIG. 1. However, these methods may additionally or alternatively be executed by any one system, or any combination of systems, including, but not limited to, those described herein.

FIG. 7 is a flow diagram showing a method 700 for identifying physical interfaces, in accordance with some embodiments of the present disclosure. The method 700, at block 702, includes accessing one or more architecture specifications having a logical interface associated with a plurality of elements of an architecture. For example, application 110 may access ICD(s) 114 that specify one or more logical interfaces associated with architecture element(s) 130 and/or sensor(s) 112.

At block 704, one or more physical interfaces is identified, the physical interfaces representing one or more procedures to be performed in association with the plurality of elements. For example, concretizer 116 may use processor 118 to recursively identify physical interfaces and associated procedures to perform, using architecture element(s) 130, the one or more functionalities indicated by the logical interface.

At block 706, one or more procedures is performed using the plurality of elements. For example, once one or more procedures associated with a physical interface are identified, the procedures may be performed by architecture element(s) 130 and/or sensor(s) 112 using processor 118. After block 706, method 700 may terminate.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which two or more clocks are synchronized.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs) that process textual, image, sensor, audio, and/or other data types, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. For example, the vehicle 800 may be capable of conditional automation (Level 3), high automation (Level 4), and/or full automation (Level 5), depending on the embodiment.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more CPU(s), system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, and/or to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) 846 (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the HD map 822 of FIG. 8C), location data (e.g., the location of the vehicle 800, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824, which may use one or more wireless antenna(s) 826 and/or modem(s) to communicate over one or more networks. For example, the network interface 824 may be capable of communication over LTE, WCDMA, UMTS, GSM, CDMA2000, etc. The wireless antenna(s) 826 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASTL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that includes portions of the environment in front of the vehicle 800 (e.g., front-facing cameras) may be used for surround view, to help identify forward-facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may any number of wide-view cameras 870 on the vehicle 800. In addition, long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

One or more stereo cameras 868 may also be included in a front-facing configuration. The stereo camera(s) 868 may include an integrated control unit comprising a scalable processing unit, which may provide a programmable logic (e.g., FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that includes portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned around the vehicle 800. The surround camera(s) 874 may include wide-view camera(s) 870, fisheye camera(s), 360-degree camera(s), and/or the like. For example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround-view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C is illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800 and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use computer-based application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting, and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected to both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. For example, the PVA may be used to process raw RADAR data (e.g., using a 4D Fast Fourier Transform) to provide a processed RADAR signal before emitting the next RADAR pulse. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 816 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe-stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. An in-cabin monitoring camera sensor is preferably monitored by a neural network running on another instance of the advanced SoC, configured to identify in-cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and actively performing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provide semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always-on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, which use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include an SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828, which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858 (e.g., GPS and/or assisted GPS sensors), to assist in mapping, perception, occupancy grid generation, and/or path planning functions. Any number of GNSS sensor(s) 858 may be used, including, for example and without limitation, a GPS using a USB connector with an Ethernet to serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data, in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the surrounding of the vehicle 800 at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor system may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 100 m, with an accuracy of 2 cm-3 cm, and with support for a 100 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a five nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include an SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjusts the vehicle speed to maintain a safe distance from vehicles ahead. Lateral ACC performs distance keeping, and advises the vehicle 800 to change lanes when necessary. Lateral ACC is related to other ADAS applications such as LC and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication links. In general, the V2V communication concept provides information about the immediately preceding vehicles (e.g., vehicles immediately ahead of and in the same lane as the vehicle 800), while the I2V communication concept provides information about traffic farther ahead. CACC systems may include either or both I2V and V2V information sources. Given the information of the vehicles ahead of the vehicle 800, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. An LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detect and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output can be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity make the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware used by the primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network that is trained and thus reduces the risk of false positives, as described herein.

The vehicle 800 may further include the infotainment SoC 830 (e.g., an in-vehicle infotainment system (IVI)). Although illustrated and described as an SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 800. For example, the infotainment SoC 830 may include radios, disk players, navigation systems, video players, USB and Bluetooth connectivity, carputers, in-car entertainment, Wi-Fi, steering wheel audio controls, hands-free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe-stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced roadwork. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

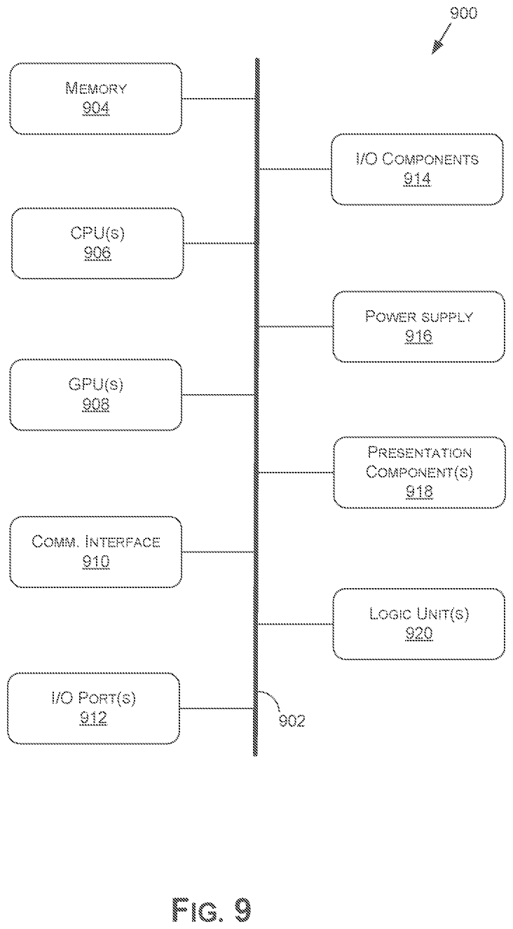

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, I/O ports 912, input/output components 914, a power supply 916, one or more presentation components 918 (e.g., display(s)), and one or more logic units 920.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “augmented reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point, connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), I/O elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, including wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 912 may enable the computing device 900 to be logically coupled to other devices including the I/O components 914, the presentation component(s) 918, and/or other components, some of which may be built into (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:

1. A method comprising: accessing one or more logical interfaces indicating one or more dependencies of one or more functionalities associated with a plurality of components; based on the one or more logical interfaces, recursively determining one or more physical interfaces of the plurality of components; and using the one or more physical interfaces to perform an operation using the plurality of components.

2. The method of clause 1, wherein the plurality of components correspond to a first level of an architecture and the one or more physical interfaces are associated with a second plurality of components corresponding to a second level of the architecture.

3. The method of clauses 1 or 2, wherein recursively determining the one or more physical interfaces further comprises: identifying one or more inter-dependent functionalities associated with a plurality of child components of the plurality of components; and identifying the one or more physical interfaces based on the one or more inter-dependent functionalities associated with the plurality of child components of the plurality of components.

4. The method of any one of clauses 1-3, wherein the one or more logical interfaces are defined in one or more documents comprising one or more requirements of the one or more functionalities associated with the plurality of components.

5. The method of any one of clauses 1-4, wherein the one or more physical interfaces concretize the one or more logical interfaces.

6. The method of any one of clauses 1-5, wherein the operation is a verification operation that verifies that the one or more functionalities associated with the plurality of components is satisfied.

7. The method of any one of clauses 1-6, wherein the plurality of components include one or more of hardware, software, hardware parts, or software units.

8. The method of any one of clauses 1-7, wherein the one or more logical interfaces comprise at least one event indicating one or more preconditions, outcomes, or concurrencies associated with the plurality of components.

9. The method of any one of clauses 1-8, wherein the one or more physical interfaces comprise one or more procedures to be performed by the plurality of components.

10. A system comprising: one or more processing units to: access one or more architecture specifications having a logical interface associated with a plurality of elements of an architecture, identify, using at least the logical interface, one or more physical interfaces representing a procedure to be performed in association with the plurality of elements, and perform the procedure in association with the plurality of elements.

11. The system of clause 10, wherein the one or more processing units are to:

identify one or more inter-dependent functionalities associated with a plurality of child elements of the plurality of elements; and identify the one or more physical interfaces based on the one or more inter-dependent functionalities associated with the plurality of child elements.

12. The system of clauses 10 or 11, wherein the one or more physical interfaces concretize the logical interface.

13. The system of any one of clauses 10-12, wherein the plurality of elements correspond to a first level of the architecture and the one or more physical interfaces are associated with a second plurality of elements corresponding to a second level of the architecture.

14. The system of any one of clauses 10-13, wherein the first level of the architecture is associated with a requirement definition that indicates one or more expectations of the plurality of elements corresponding to the second plurality of elements.

15. The system of any one of clauses 10-14, wherein the plurality of elements include at least one of hardware, software, hardware parts, or software units.

16. The system of any one of clauses 10-15, wherein the procedure is a verification operation that verifies that one or more functionalities associated with the plurality of elements is satisfied.

17. The system of any one of clauses 10-16, wherein the logical interface comprises at least one event indicating one or more preconditions, outcomes, or concurrencies associated with the plurality of elements.

18. The system of any one of clauses 10-17, wherein the logical interface is defined in one or more documents comprising one or more requirements of one or more functionalities associated with the plurality of elements.

19. A processor comprising: one or more processing units to perform operations comprising: determining one or more physical events associated with a plurality of components based on a logical interface specification associated with the plurality of components; and using the one or more physical events to identify one or more procedures associated with the plurality of components.

20. The processor of clause 19, wherein the processor is comprised in at least one of: a control system for an autonomous or semi-autonomous machine; a perception system for an autonomous or semi-autonomous machine; a first system for performing simulation operations; a second system for performing deep learning operations; a third system implemented using an edge device; a fourth system implemented using a robot; a fifth system incorporating one or more virtual machines (VMs); a sixth system implemented at least partially in a data center; a seventh system for performing digital twin operations; an eighth system for performing light transport simulation; a ninth system for performing collaborative content creation for 3D assets; a tenth system for performing conversational Artificial Intelligence operations; an eleventh system for generating synthetic data; a twelfth system for implementing a web-hosted service for detecting program workload inefficiencies; an application as an application programming interface (“API”); a thirteenth system implemented at least partially using cloud computing resources; a fourteenth system for presenting one or more of virtual reality content, augmented reality content, or mixed reality content; or a fifteenth system implementing one or more large language models (LLMs).

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
accessing one or more logical interfaces indicating one or more dependencies of one or more functionalities associated with a plurality of components;
based on the one or more logical interfaces, recursively determining one or more physical interfaces of the plurality of components; and
using the one or more physical interfaces to perform an operation using the plurality of components.

2. The method of claim 1, wherein the plurality of components correspond to a first level of an architecture and the one or more physical interfaces are associated with a second plurality of components corresponding to a second level of the architecture.

3. The method of claim 1, wherein recursively determining the one or more physical interfaces further comprises:
identifying one or more inter-dependent functionalities associated with a plurality of child components of the plurality of components; and
identifying the one or more physical interfaces based on the one or more inter-dependent functionalities associated with the plurality of child components of the plurality of components.

4. The method of claim 1, wherein the one or more logical interfaces are defined in one or more documents comprising one or more requirements of the one or more functionalities associated with the plurality of components.

5. The method of claim 1, wherein the one or more physical interfaces concretize the one or more logical interfaces.

6. The method of claim 1, wherein the operation is a verification operation that verifies that the one or more functionalities associated with the plurality of components is satisfied.

7. The method of claim 1, wherein the plurality of components include one or more of hardware, software, hardware parts, or software units.

8. The method of claim 1, wherein the one or more logical interfaces comprise at least one event indicating one or more preconditions, outcomes, or concurrencies with the plurality of components.

9. The method of claim 1, wherein the one or more physical interfaces comprise one or more procedures to be performed by the plurality of components.

10. A system comprising:
one or more processing units to:
access one or more architecture specifications having a logical interface associated with a plurality of elements of an architecture,
identify, using at least the logical interface, one or more physical interfaces representing a procedure to be performed in association with the plurality of elements, and
perform the procedure in association with the plurality of elements.

11. The system of claim 10, wherein the one or more processing units are to:
identify one or more inter-dependent functionalities associated with a plurality of child elements of the plurality of elements; and
identify the one or more physical interfaces based on the one or more inter-dependent functionalities associated with the plurality of child elements.

12. The system of claim 10, wherein the one or more physical interfaces concretize the logical interface.

13. The system of claim 10, wherein the plurality of elements correspond to a first level of the architecture and the one or more physical interfaces are associated with a second plurality of elements corresponding to a second level of the architecture.

14. The system of claim 13, wherein the first level of the architecture is associated with a requirement definition that indicates one or more expectations of the plurality of elements corresponding to the second plurality of elements.

15. The system of claim 10, wherein the plurality of elements include at least one of hardware, software, hardware parts, or software units.

16. The system of claim 10, wherein the procedure is a verification operation that verifies that one or more functionalities associated with the plurality of elements is satisfied.

17. The system of claim 10, wherein the logical interface comprises at least one event indicating one or more preconditions, outcomes, or concurrencies with the plurality of elements.

18. The system of claim 10, wherein the logical interface is defined in one or more documents comprising one or more requirements of one or more functionalities associated with the plurality of elements.

19. A processor comprising:
one or more processing units to perform operations comprising:
determining one or more physical events associated with a plurality of components based on a logical interface specification associated with the plurality of components; and
using the one or more physical events to identify one or more procedures associated with the plurality of components.

20. The processor of claim 19, wherein the processor is comprised in at least one of:
a control system for an autonomous or semi-autonomous machine;
a perception system for an autonomous or semi-autonomous machine;
a first system for performing simulation operations;
a second system for performing deep learning operations;
a third system implemented using an edge device;
a fourth system implemented using a robot;
a fifth system incorporating one or more virtual machines (VMs);
a sixth system implemented at least partially in a data center;
a seventh system for performing digital twin operations;
an eighth system for performing light transport simulation;
a ninth system for performing collaborative content creation for 3D assets;
a tenth system for performing conversational Artificial Intelligence operations;
an eleventh system for generating synthetic data;
a twelfth system for implementing a web-hosted service for detecting program workload inefficiencies;
an application as an application programming interface (“API”);
a thirteenth system implemented at least partially using cloud computing resources;
a fourteenth system for presenting one or more of virtual reality content, augmented reality content, or mixed reality content; or
a fifteenth system implementing one or more large language models (LLMs).
